(19) United States
(12) Patent Application Publication
(10) Pub. No.: US 2022/0369566 A1
(43) Pub. Date: Nov. 24, 2022

(54) INDOOR GARDENING APPLIANCE WITH AUTOMATED LIGHTING AND HYDRATION SYSTEMS

(71) Applicant: Haier US Appliance Solutions, Inc., Wilmington, DE (US)

(72) Inventors: Srikanth Raavi Venkata, Louisville, KY (US); Abdel Hamad, Louisville, KY (US)

(21) Appl. No.: 17/323,151

(22) Filed: May 18, 2021

(51) Int. Cl. A01G 7/04; A01G 27/00

(52) U.S. Cl. CPC A01G 7/045; A01G 27/008

(57) ABSTRACT

An indoor gardening appliance includes a plant support frame defining a plurality of apertures for supporting one or more plant pods above a collection reservoir that collects excess water. A pump recirculates water from the collection reservoir onto the plant support frame where it is distributed among plants through distribution channels. A light assembly is positioned above the plant support frame and selectively illuminates the plant support frame based on ambient lighting conditions as measured by a light sensor.

### FIELD OF THE INVENTION

The present subject matter relates generally to systems for gardening plants indoors, and more particularly, to an indoor gardening appliance with automated lighting and hydration systems.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

However, conventional artificial lighting systems are designed to use artificial light to meet all lighting needs for plants within the appliance, as these appliances typically include a cabinet enclosing all plants. As such, the artificial lighting systems operate in a time-based manner and use only artificial light. In addition, indoor gardening appliances commonly require complex hydration systems connected to an external water supply for meeting the hydration needs of plants growing therein. These indoor gardening appliances frequently require substantial manual intervention by a user in order to facilitate the plant growth process. For example, during the growth cycle of each plant, a user may be required to periodically regulate the water or lighting needs of the plants, add nutrients, etc.

Accordingly, an improved indoor garden center would be useful. More particularly, an indoor garden center with improved, automated lighting and hydration systems would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an indoor gardening appliance defining a vertical direction is provided. The indoor gardening appliance includes a plant support frame defining a plurality of apertures for receiving one or more plant pods, a light assembly positioned above the plant support frame for selectively illuminating the plant support frame, a light sensor positioned adjacent the plant support frame, and a controller operably coupled to the light assembly and the light sensor. The controller is configured to measure an ambient light level using the light sensor, determine that the ambient light level has dropped below a predetermined light threshold, and operate the light assembly to illuminate the plant support frame in response to determining that the ambient light level has dropped below the predetermined light threshold.

In another exemplary embodiment, an indoor gardening appliance defining a vertical direction is provided. The indoor gardening appliance includes a plant support frame defining a plurality of apertures for receiving one or more plant pods, a collection reservoir positioned below the plant support frame for collecting water, a fluid conduit fluidly coupled to the collection reservoir and defining a discharge port adjacent the plant support frame to discharge the water onto the plant support frame, and a recirculation pump fluidly coupled to the fluid conduit for selectively recirculating the water collected in the collection reservoir back onto the plant support frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor gardening appliance according to an exemplary embodiment of the present subject matter.

FIG. 2 provides a front view of the exemplary indoor gardening appliance of FIG. 1 with light panels of a lighting assembly in an activated position according to an exemplary embodiment of the present subject matter.

FIG. 3 provides a front view of the exemplary indoor gardening appliance of FIG. 1 with the light panels in a deactivated position according to an exemplary embodiment of the present subject matter.

FIG. 4 provides a perspective view of the exemplary lighting assembly of FIG. 2 according to an exemplary embodiment of the present subject matter.

FIG. 5 provides a close-up, perspective view of a plant support frame of the exemplary indoor gardening appliance of FIG. 1 according to an exemplary embodiment of the present subject matter.

FIG. 6 provides a front, schematic view of the exemplary indoor gardening appliance of FIG. 1 according to exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

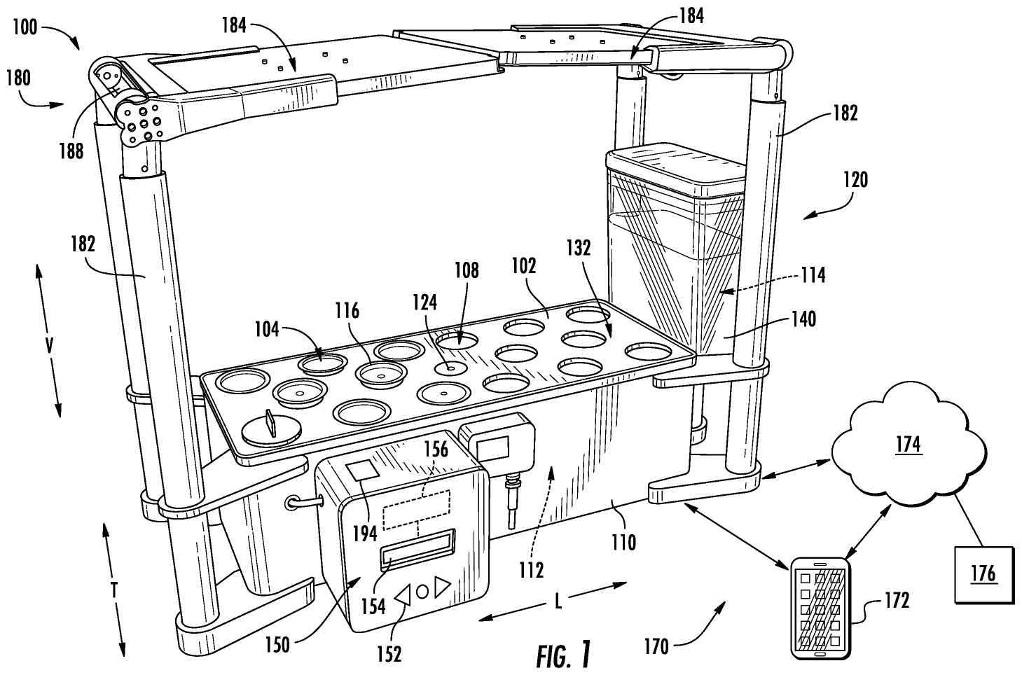

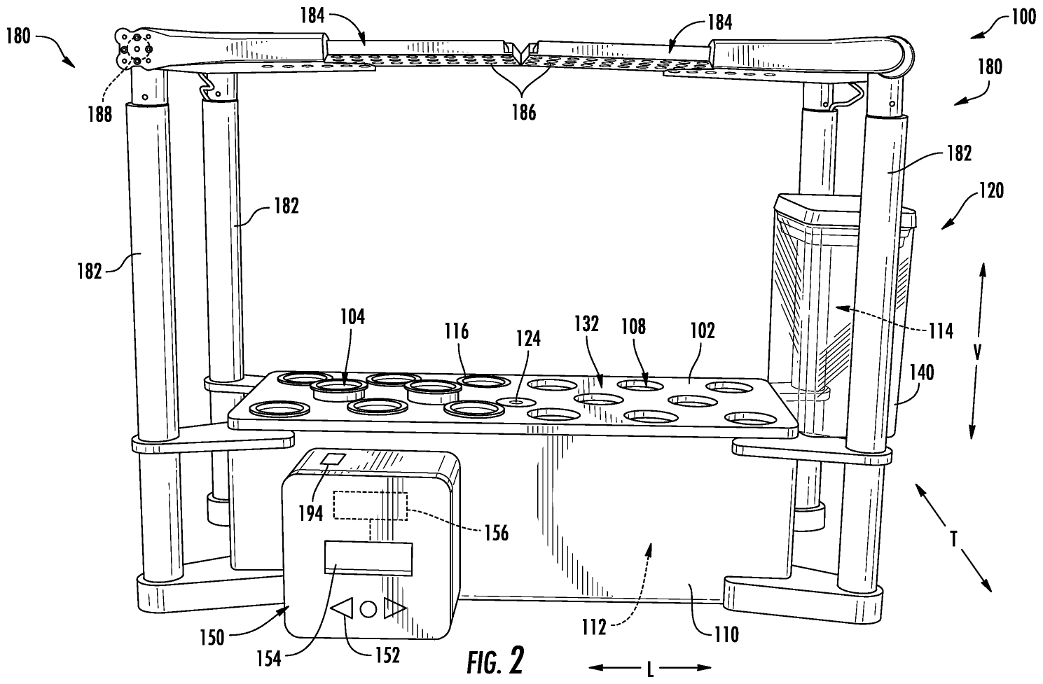

Referring now to the figures, an exemplary indoor gardening appliance 100 will be described in accordance with exemplary aspects of the present subject matter. Specifically, FIGS. 1 through 4 provide various perspective views of the indoor gardening appliance 100. As illustrated, indoor gardening appliance 100 generally defines a vertical direction V, a lateral direction L, and a transverse direction T, each of which is mutually perpendicular, such that an orthogonal coordinate system is generally defined.

As shown, indoor gardening appliance 100 includes a plant support frame 102 that is generally configured for receiving one or more plant pods (e.g., as identified herein generally by reference numeral 104). Plant pods 104 may remain within plant support frame 102 through an entire growth cycle (e.g., planting to harvest) of an indoor gardening appliance 100. Specifically, plant pods 104 generally contain seedlings or other material positioned within soil in a permeable container for growing plants (e.g., identified herein generally by reference numeral 106).

As shown, a plurality of apertures 108 are defined through plant support frame 102, each aperture 108 being configured for receiving a single plant pod 104. In addition, according to the illustrated embodiment, plant support frame 102 is positioned over or seated on a lower housing 110 that defines a collection reservoir 112 for containing water (e.g., as identified herein generally by reference numeral 114) to facilitate the plant growth process. It should be appreciated that the term “water” and the like are generally used herein to refer to any hydrating solution for facilitating plant growth, such as water, nutrients, or any suitable mixtures thereof.

To initiate a growth cycle of a plant pod 104, a user may insert a portion of plant pod 104 (e.g., a seed end or root end) having the desired seeds through one of the plurality of apertures 108 into collection reservoir 112. A portion of plant pod 104 may be supported above plant support frame 102, e.g., by a supporting flange 116 defined on a top end of plant pod 104. In order to prevent the evaporation of water from collection reservoir 112, indoor gardening appliance 100 may further include one or more removable covers (not shown) that are removably mounted over each aperture 108 when a plant pod 104 is not inserted into that respective aperture 108.

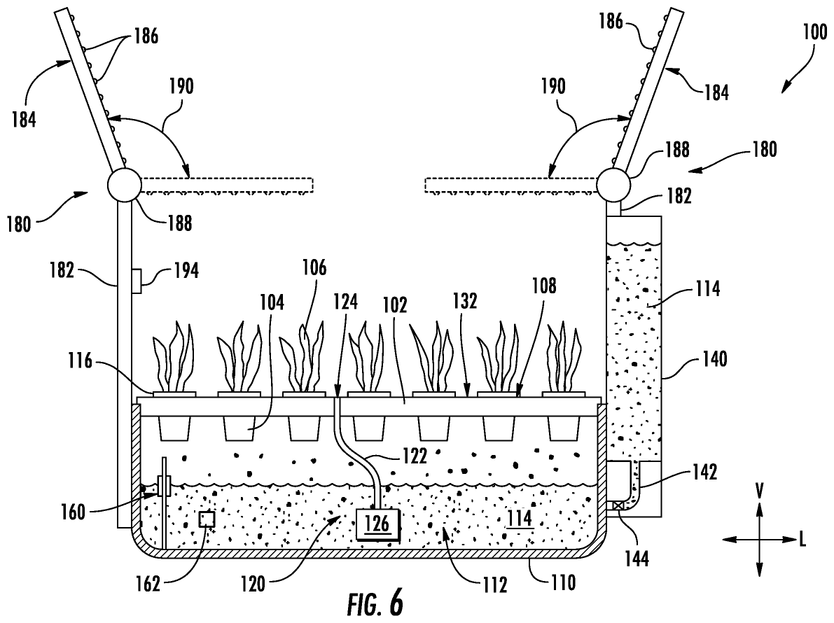

As best shown in FIG. 6, collection reservoir 112 is generally part of a hydration system 120 of indoor gardening appliance 100 that is configured for providing water 114 to the plant pods 104 to facilitate plant growth. Specifically, hydration system 120 is generally configured for containing enough water 114 to support the growth of the plants within indoor gardening appliance 100 for a complete growth cycle. As used herein, the term “growth cycle” is generally intended to refer to the lifecycle of plants 106 from seedlings or when plant pod 104 is first inserted into plant support frame 102 until harvest.

According to the illustrated embodiment, collection reservoir 112 collects water 114 as it drips from plant pods 104. In this manner, plant pods 104 may be generally configured for absorbing the desired amount of hydration or otherwise becoming saturated as needed for plant growth, and the remaining water 114 may fall under the force of gravity and collect in collection reservoir 112. As illustrated, hydration system 120 further includes a fluid conduit 122 that is fluidly coupled to collection reservoir 112 for providing a flow of water 114 back onto plant support frame 102 during a hydration process. More specifically, fluid conduit 122 may be coupled to a discharge port 124 that is positioned adjacent plant support frame 102 for discharging a flow of water 114 onto plant support frame 102.

Hydration system 120 may further include a recirculation pump 126 that is operably coupled to fluid conduit 122 for selectively recirculating water 114 collected in collection reservoir 112 back onto plant support frame 102 during a hydration cycle. It should be appreciated that this hydration cycle may be performed according to a periodic schedule to hydrate plants 106. According to still other embodiments, hydration system 120 may include a moisture sensor positioned in one or more of the plant pods 104 for determining when more water 114 is needed. According to such an embodiment, recirculation pump 126 may be activated when such a moisture sensor indicates the plants 106 need to be watered.

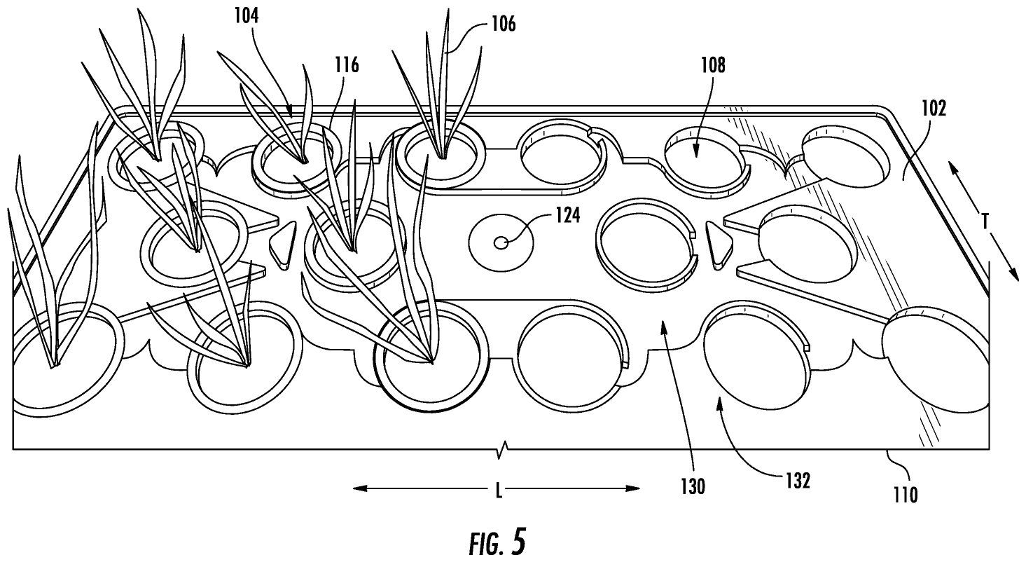

Referring now briefly to FIG. 5, plant support frame 102 may define a plurality of distribution channels 130 that are generally configured for distributing water 114 to each of the plurality of apertures 108. In this regard, distribution channels 130 are recessed relative to an upper surface 132 of the plant support frame 102, such that distribution channels 130 are flooded with water 114 during a hydration cycle. In this manner, distribution channels 130 may be sized to direct a substantially equivalent portion of the flow of water 114 to each plant pod 104. As shown, support flange 116 of plant pods 104 may be seated on upper surface 132 of plant support frame 102 such that the water 114 may be directed toward the roots of plant pods 104 to saturate the roots prior to draining into collection reservoir 112.

In addition, according to the illustrated embodiment, discharge port 124 of fluid conduit 122 may be defined in a center of plant support frame 102 (e.g., within a horizontal plane defined by the lateral direction L and the transverse direction T). Specifically, discharge port 124 is defined within the distribution channels 130 such that activation of recirculation pump 126 provides a flow of water 114 from collection reservoir 112 to flood or otherwise provide a flow of water 114 into distribution channels 130 during a hydration process. It should be appreciated that other configurations of plant support frame 102, distribution channels 130, and other portions of hydration system 120 are possible and within the scope of the present subject matter.

Referring still generally to FIGS. 1 through 6, hydration system 120 may include a secondary reservoir 140 for holding additional water 114. In this regard, as the water 114 within collection reservoir 112 is slowly absorbed by plants 106 during plant growth, the water level within collection reservoir 112 may slowly drop. As a result, it may be desirable to replenish the water 114 and nutrients in collection reservoir 112, e.g., by using the water 114 in secondary reservoir 140 as described herein. Specifically, as shown in FIG. 6, secondary reservoir 140 may be fluidly coupled to collection reservoir 112 through a supply line 142. A supply valve 144 may be fluidly coupled to supply line 142 for regulating the flow of water 114 from secondary reservoir 140 into collection reservoir 112. As illustrated, secondary reservoir 140 is generally positioned above collection reservoir 112 such that water 114 may flow from secondary reservoir 140 under the force of gravity into collection reservoir 112 when supply valve 144 is open.

Referring again to FIG. 1, indoor gardening appliance 100 may include a control panel 150 that may represent a general-purpose Input/Output (“GPIO”) device or functional block for indoor gardening appliance 100. In some embodiments, control panel 150 may include or be in operative communication with one or more user input devices 152, such as one or more of a variety of digital, analog, electrical, mechanical, or electro-mechanical input devices including rotary dials, control knobs, push buttons, toggle switches, selector switches, and touch pads. Additionally, indoor gardening appliance 100 may include a display 154, such as a digital or analog display device generally configured to provide visual feedback regarding the operation of indoor gardening appliance 100. For example, display 154 may be provided on control panel 150 and may include one or more status lights, screens, or visible indicators. According to exemplary embodiments, user input devices 152 and display 154 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Indoor gardening appliance 100 may further include or be in operative communication with a processing device or a controller 156 that may be generally configured to facilitate appliance operation. In this regard, control panel 150, user input devices 152, and display 154 may be in communication with controller 156 such that controller 156 may receive control inputs from user input devices 152, may display information using display 154, and may otherwise regulate operation of indoor gardening appliance 100. For example, signals generated by controller 156 may operate indoor gardening appliance 100, including any or all system components, subsystems, or interconnected devices, in response to the position of user input devices 152 and other control commands. Control panel 150 and other components of indoor gardening appliance 100 may be in communication with controller 156 via, for example, one or more signal lines or shared communication busses. In this manner, Input/Output (“I/O”) signals may be routed between controller 156 and various operational components of indoor gardening appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 156 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 156 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 156 may be operable to execute programming instructions or micro-control code associated with an operating cycle of indoor gardening appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 156 as disclosed herein is capable of and may be operable to perform any methods, method steps, or portions of methods as disclosed herein. For example, in some embodiments, methods disclosed herein may be embodied in programming instructions stored in the memory and executed by controller 156.

The memory devices may also store data that can be retrieved, manipulated, created, or stored by the one or more processors or portions of controller 156. The data can include, for instance, data to facilitate performance of methods described herein. The data can be stored locally (e.g., on controller 156) in one or more databases and/or may be split up so that the data is stored in multiple locations. In addition, or alternatively, the one or more database(s) can be connected to controller 156 through any suitable network(s), such as through a high bandwidth local area network (LAN) or wide area network (WAN). In this regard, for example, controller 156 may further include a communication module or interface that may be used to communicate with one or more other component(s) of indoor gardening appliance 100, controller 156, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As best shown in FIG. 6, hydration system 120 may further include a water level sensor 160 that is positioned within collection reservoir 112 for measuring a level of water 114 therein. In this manner, feedback from water level sensor 160 may be used to determine when to open supply valve 144 to supply additional water 114 into collection reservoir 112. In this manner, hydration system 120 may generally be configured to maintain an optimum level of water 114 within collection reservoir 112 to facilitate improved growth of plants 106. Specifically, controller 156 of indoor gardening appliance 100 may generally be configured for measuring the water level within collection reservoir 112 using water level sensor 160, determining that the water level has fallen below a predetermined water level threshold, and regulating supply valve 144 to discharge a flow of water 114 into collection reservoir 112, e.g., until the desired amount of water 114 is contained within collection reservoir 112. As mentioned above, collection reservoir 112 and secondary reservoir 140 may generally contain enough water and nutrients for one full plant growth cycle.

As also shown in FIG. 6, hydration system 120 may further include a water quality sensor 162 that is generally configured for monitoring the quality of water 114 within collection reservoir 112. In this regard, water quality sensor 162 may be any suitable type of sensor, such as a sensor that measures total dissolved solids, a pH sensor, or any other suitable sensor that detects quantitative or qualitative information regarding the quality of water 114 or nutrients therein. Notably, this water quality may be used to determine when additional water from secondary reservoir 140 needs to be added or may otherwise be used to determine when collection reservoir 112 needs to be emptied and refilled. In this regard, controller 156 may monitor the water quality of water 114 within collection reservoir 112, determine that the water quality has fallen below a predetermined water quality, and provide a user notification as to such a condition. In this regard, for example, the user notification may be provided via a display 154, may be provided through an external device 172 (described below), or may be provided in any other suitable manner.

Referring still to FIG. 1, a schematic diagram of an external communication system 170 will be described according to an exemplary embodiment of the present subject matter. In general, external communication system 170 is configured for permitting interaction, data transfer, and other communications between indoor gardening appliance 100 and one or more external devices. For example, this communication may be used to provide and receive operating parameters, user instructions or notifications, performance characteristics, user preferences, or any other suitable information for improved performance of indoor gardening appliance 100. In addition, it should be appreciated that external communication system 170 may be used to transfer data or other information to improve performance of one or more external devices or appliances and/or improve user interaction with such devices.

For example, external communication system 170 permits controller 156 of indoor gardening appliance 100 to communicate with a separate device external to indoor gardening appliance 100, referred to generally herein as an external device 172. As described in more detail below, these communications may be facilitated using a wired or wireless connection, such as via a network 174. In general, external device 172 may be any suitable device separate from indoor gardening appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with indoor gardening appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control indoor gardening appliance 100, etc. In addition, external device 172 and remote server 176 may communicate with indoor gardening appliance 100 to communicate similar information.

In general, communication between indoor gardening appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with indoor gardening appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring again generally to FIGS. 1 through 6, indoor gardening appliance 100 may further include a lighting system that is generally configured for selectively illuminating plants 106 to facilitate an improved growth process. Although an exemplary lighting system will be described below, it should be appreciated that this lighting system is only exemplary and intended to describe aspects of the present subject matter. Variations and modifications may be made to the lighting system while remaining within the scope of the present subject matter.

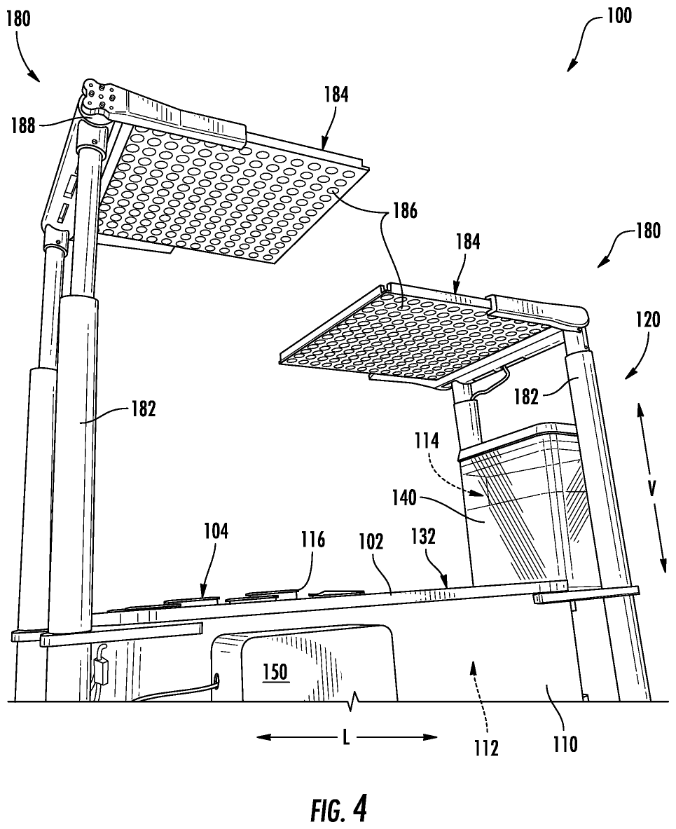

Specifically, as illustrated, indoor gardening appliance 100 may include a light assembly 180 that is positioned above plant support frame 102 for selectively illuminating plant support frame 102 and plants 106 positioned therein. In this regard, for example, light assembly 180 may generally include one or more support arms 182 that extend above plant support frame 102 along the vertical direction V. One or more light panels 184 may be pivotally mounted to the support arms 182 and may comprise a plurality of light sources 186. As best shown in FIG. 4, support arms 182 may generally be movable along the vertical direction V, e.g., to accommodate the height plants 106 as they grow tall.

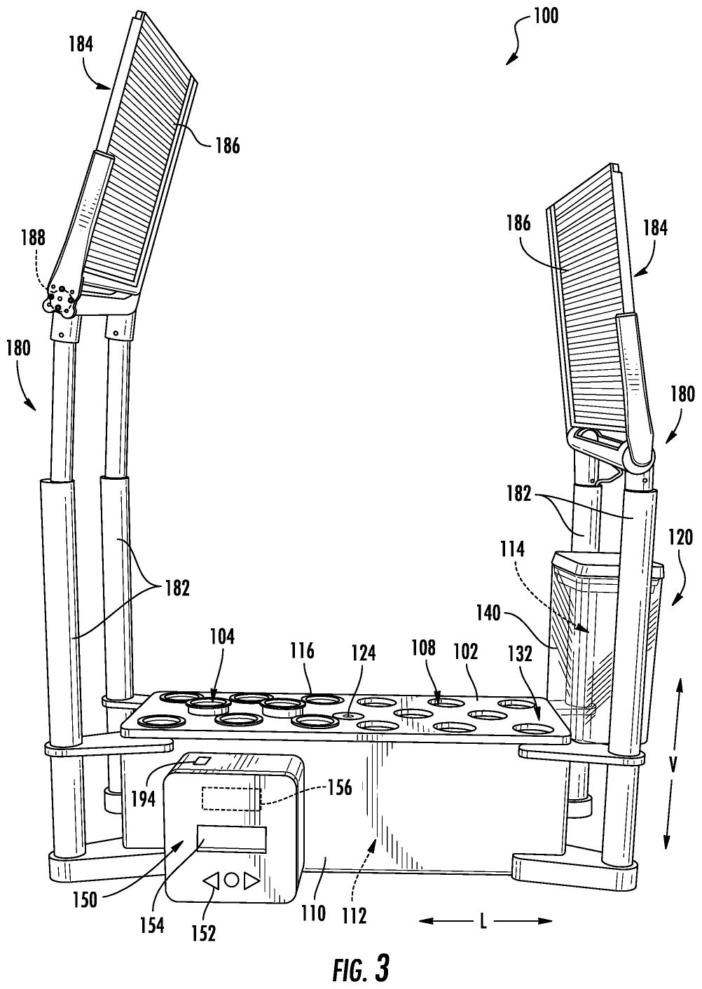

In addition, light assembly 180 may include a motor assembly 188 that is operably coupled to light panels 184 to selectively pivot light panels 184 between an activated position (e.g., as shown in FIG. 1 and dotted lines in FIG. 6) and a deactivated position (e.g., as shown in FIG. 3 and solid lines in FIG. 6). Notably, light sources 186 may generally be illuminated when light panels 184 are in the activated position and deenergized when light panels 184 are in the deactivated position. Although a single light assembly 180 is described herein, it should be appreciated that indoor gardening appliance 100 may include any suitable number of light assemblies. For example, the illustrated embodiment includes two light assemblies 180 positioned on opposite sides of plant support frame 102. It should be appreciated that these light assemblies may be operated in unison or may be operated independently from each other.

Light sources 186 may be provided as any suitable number, type, position, and configuration of electrical light source(s), using any suitable light technology and illuminating in any suitable color. For example, according to the illustrated embodiment, light source 186 includes one or more light emitting diodes (LEDs), which may each illuminate in a single color (e.g., white LEDs), or which may each illuminate in multiple colors (e.g., multi-color or RGB LEDs) depending on the control signal from controller 156. For example, according to an exemplary embodiment, light assembly 180 may include at least one of a white light emitting diode, a red light emitting diode, a pink light emitting diode, or an LED of any other suitable color. However, it should be appreciated that according to alternative embodiments, light sources 186 may include any other suitable traditional light bulbs or sources, such as halogen bulbs, fluorescent bulbs, incandescent bulbs, glow bars, a fiber light source, ultraviolet lights, etc.

According to the illustrated embodiment, motor assembly 188 may generally be positioned within a joint that couples support arms 182 and light panels 184. As used herein, “motor” may refer to any suitable drive motor and/or transmission assembly for rotating light panels 184. For example, motor assembly 188 may include a brushless DC electric motor, a stepper motor, or any other suitable type or configuration of motor. For example, motor assembly 188 may include an AC motor, an induction motor, a permanent magnet synchronous motor, or any other suitable type of AC motor. In addition, motor assembly 188 may include any suitable transmission assemblies, clutch mechanisms, or other components. According to an exemplary embodiment, motor assembly 188 may be operably coupled to a controller (e.g., controller 156), which is programmed to rotate by panels 184 as described herein.

In general, indoor gardening appliance 100 may be designed to maximize the utilization of ambient light, e.g., sunlight, as this may generally be more natural and healthy for plants 106. However, when ambient light is not available to plants 106, e.g., due to heavy cloud cover or nighttime conditions, indoor gardening appliance 100 may be configured for using light assembly 180 to supplement the light received by plants 106. According to exemplary embodiments, plants 106 may be illuminated 24 hours a day, e.g., either by sunlight or light generated from light assembly 180.

Specifically, in order to maximize the ambient light that is received by plants 106, light panels 184 may pivot away from plant support frame 102 when light assembly 180 is deactivated, e.g., to remove any physical barrier to light reaching plants 106. Specifically, according to the illustrated embodiment, motor assembly 188 may be configured for pivoting light panel 184 through a pivot angle 190 (e.g., see FIG. 6). According to the illustrated embodiment, light panels 184 may be oriented in a horizontal plane in the activated position and may pivot through pivot angle 190 to reach the deactivated position. According to exemplary embodiments, pivot angle 190 may be greater than about 45°, greater than about 60°, greater than about 70°, greater than about 80°, greater than about 90°, or greater than about 120°.

As shown generally in FIGS. 1 through 6, indoor gardening appliance 100 may further include a light sensor 194 that is positioned adjacent plant support frame 102 for detecting ambient light levels surrounding indoor gardening appliance 100. In this manner, controller 156 may be operably coupled to light assembly 180 and light sensor 194 for regulating the operation of light assembly 180 in response to ambient light conditions as detected by light sensor 194. Specifically, according to exemplary embodiments, controller 156 may be configured to measure an ambient light level using light sensor 194, determine that the ambient light level has dropped below a predetermined light threshold (e.g., corresponding to sunset or nighttime conditions), and operate light assembly 180 to illuminate plant support frame 102 and plants 106 positioned thereon to compensate for the lack of ambient growth light. In addition, controller 156 may be configured to deactivate light assemblies 180 when ambient light conditions are sufficient to facilitate plant growth. Specifically, controller 156 may be configured to determine that the ambient light level has exceeded the predetermined light threshold and may deactivate light assembly 180 in response to the elevated ambient light conditions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An indoor gardening appliance defining a vertical direction, the indoor gardening appliance comprising:
a plant support frame defining a plurality of apertures for receiving one or more plant pods;
a light assembly positioned above the plant support frame for selectively illuminating the plant support frame;
a light sensor positioned adjacent the plant support frame; and
a controller operably coupled to the light assembly and the light sensor, wherein the controller is configured to:
measure an ambient light level using the light sensor;
determine that the ambient light level has dropped below a predetermined light threshold; and
operate the light assembly to illuminate the plant support frame in response to determining that the ambient light level has dropped below the predetermined light threshold.

2. The indoor gardening appliance of claim 1, wherein the light assembly comprises:
a support arm that extends above the plant support frame along the vertical direction;
a light panel pivotally mounted to the support arm and comprising a plurality of light sources; and
a motor assembly operably coupled to the light panel to selectively pivot the light panel between an activated position and a deactivated position.

3. The indoor gardening appliance of claim 2, wherein a pivot angle defined between the light panel in the activated position and the light panel in the deactivated position is greater than 70 degrees.

4. The indoor gardening appliance of claim 3, wherein the pivot angle is greater than 90 degrees.

5. The indoor gardening appliance of claim 2, wherein the support arm is movable along the vertical direction to accommodate larger plants.

6. The indoor gardening appliance of claim 2, wherein the support arm is a first support arm, the light panel is a first light panel, the plurality of light sources is a plurality of first light sources, and the motor assembly is a first motor assembly, and wherein the light assembly comprises:
a second support arm that extends above the plant support frame along the vertical direction;
a second light panel pivotally mounted to the second support arm and comprising a plurality of second light sources; and
a second motor assembly operably coupled to the second light panel to selectively pivot the second light panel between an activated position and a deactivated position.

7. The indoor gardening appliance of claim 6, wherein the second support arm, the second light panel, and the second motor assembly operate independently from the first support arm, the first light panel, and the first motor assembly.

8. The indoor gardening appliance of claim 1, wherein the light assembly comprises at least one of light emitting diode.

9. The indoor gardening appliance of claim 1, further comprising a hydration system comprising:
a collection reservoir positioned below the plant support frame for collecting water;
a fluid conduit fluidly coupled to the collection reservoir and defining a discharge port adjacent the plant support frame to discharge the water onto the plant support frame; and
a recirculation pump fluidly coupled to the fluid conduit for selectively recirculating the water collected in the collection reservoir back onto the plant support frame.

10. The indoor gardening appliance of claim 9, wherein the plant support frame defines a plurality of distribution channels to distribute the water to each of the plurality of apertures.

11. The indoor gardening appliance of claim 9, wherein the discharge port is defined in a center of the plant support frame.

12. The indoor gardening appliance of claim 9, wherein the hydration system further comprises:
a secondary reservoir for holding additional water; and
a supply valve for regulating a flow of water from the secondary reservoir into the collection reservoir.

13. The indoor gardening appliance of claim 12, wherein the secondary reservoir is positioned above the plant support frame.

14. The indoor gardening appliance of claim 12, wherein the collection reservoir and the secondary reservoir contain enough water and nutrients for one full plant growth cycle.

15. The indoor gardening appliance of claim 12, wherein the hydration system further comprises a water level sensor, wherein the controller is further configured to:
measure a water level in the collection reservoir;
determine that the water level has fallen below a predetermined water level threshold; and
regulate the supply valve to discharge the flow of water into the collection reservoir.

16. The indoor gardening appliance of claim 9, wherein the hydration system further comprises a water quality sensor, wherein the controller is further configured to:
measure a water quality of the water in the collection reservoir;
determine that the water quality has fallen below a predetermined water quality; and
provide a user notification that the water quality has fallen below the predetermined water quality.

17. The indoor gardening appliance of claim 16, wherein the controller is in operative communication with a remote device through an external network, and wherein the user notification is provided through the remote device.

18. The indoor gardening appliance of claim 1, wherein the controller is further configured to:
determine that the ambient light level has exceeded the predetermined light threshold; and
deactivate the light assembly in response to determining that the ambient light level has exceeded the predetermined light threshold.

19. An indoor gardening appliance defining a vertical direction, the indoor gardening appliance comprising:
a plant support frame defining a plurality of apertures for receiving one or more plant pods;
a collection reservoir positioned below the plant support frame for collecting water;
a fluid conduit fluidly coupled to the collection reservoir and defining a discharge port adjacent the plant support frame to discharge the water onto the plant support frame; and
a recirculation pump fluidly coupled to the fluid conduit for selectively recirculating the water collected in the collection reservoir back onto the plant support frame.

20. The indoor gardening appliance of claim 19, further comprising:
a secondary reservoir for holding additional water; and
a supply valve for regulating a flow of water from the secondary reservoir into the collection reservoir.
